(19) United States
(12) Patent Application Publication
(10) Pub. No.: US 2012/0188081 A1
(43) Pub. Date: Jul. 26, 2012

(54) SECURITY SYSTEM AND METHOD TO SECURE AN AREA

(75) Inventor: Antonius Gerardus Johannes Maria Van Katwijk, Volkel (NL)

(73) Assignee: INVENTOR INVEST HOLDING B.V., PH Volkel (NL)

(21) Appl. No.: 13/499,598

(22) PCT Filed: Oct. 4, 2010
(86) PCT No.: PCT/NL10/50644

§ 371 Date: Mar. 30, 2012

(30) Foreign Application Priority Data
Oct. 2, 2009 (NL) 1037342

(51) Int. Cl. G08B 13/00

(52) U.S. Cl. 340/541

(57) ABSTRACT

A security system to secure an area, the system having a sensor system to determine a location of a moving object within said area, the sensor system including a radar system; a control device connected to said sensor system; an illumination device to provide a light beam said light beam being directable to different locations in said area; and an actuator controlled by said control device to direct said light beam to a desired location, wherein said control device is configured to direct the light beam to a location where the presence of a living body is determined by said sensor system.

### FIELD

The invention relates to a security system to secure an area, for instance a business park or residential area, and a method to secure such an area.

### SUMMARY

It is desirable to secure certain areas against intruders. A first security measure taken in many of these areas is the provision of lamps which illuminate the complete area. This measure is based on the idea that if the complete area is illuminated intruders have the feeling that they can easily be seen in the area. On the other hand the provision of light also gives a potential intruder the opportunity to study the area. Thereby, a lot of energy is used to illuminate numerous business parks, parking lots and such for security while nobody is present in these areas resulting in waste of energy and light pollution. Thereby, when an intruder enters an illuminated area there is no warning signal generated which may be sent to the intruder or the owner of the area.

To further secure an area of interest, security systems having security cameras are provided. The cameras are used to survey an area. Security guards monitor the video images to control whether intruders enter the area, and/or the video images are stored on a storage device, so that the videos can be reviewed when there are reasons to believe that an intruder has entered the secured area.

It also known to provide a illumination device which illuminates the area when somebody has been detected in the area.

U.K. Patent Application Publication No. GB 2,381,979 discloses an alternative security system in which an illumination device is used for alerting an intruder of their surveillance by illuminating the area surrounding him. This security system comprises image capturing means for capturing images of an intruder, image processing means for processing the images and lighting means for illuminating the intruder. A drawback of this security system is that the system is not able to detect the presence of an intruder if no clear images can be obtained, for instance caused by sabotage of the image capturing means or due to environmental influences, such as fog or heavy rain, especially during night. Thereby, a certain basic light level has to be provided in the area to obtain the images.

A further drawback is that the security system of U.K. Patent Application Publication No. GB 2,381,979 is not capable of determining whether an intruder has actually passed the border of the area. This may have the result that someone who passes by on a pedestrian area next to the area to be secured will be illuminated by the illumination device as he is captured in an image of the image capturing means.

Likewise, it may be possible that the image capturing means captures images of an animal, for instance a cat, present in the secured area. However, it is undesirable that the presence of such an animal triggers the activation of the security system.

An aim of the invention is to provide, for example, a security system providing a solution for one or more of the above identified drawbacks of a security system, or provide an alternative security system.

Accordingly, in an embodiment of the invention, there is provided a security system to secure an area, the security system comprising:

a sensor system configured to determine a location of a moving object within said area, the sensor system comprising a radar system,

an illumination device to provide a light beam said light beam being directable to different locations in said area,

an actuator to direct said light beam to a desired location, and

a control device configured to activate, in dependence of a signal of the sensor system, the illumination device when an intruder has been identified in the area and to control the actuator to direct the light beam to the location where the intruder is located.

With such a security system, the illumination device can, when a moving object is detected in the secured area, and if desired, i.e. when the moving object is identified as an intruder, be activated and the light beam can be directed by control of the actuator to the location, i.e. the position, where the intruder is located.

Thus, the security system illuminates the location where an intruder is located by the radar system. When the intruder moves within the area, the light beam may follow the intruder until the intruder has left the area. As a result the intruder has the feeling of being surveyed in the area.

An advantage of a radar system is that such system can reliably scan the area for the presence of moving objects without negatively being influenced by environmental influences such as fog or heavy rain.

The security system may also be used in very dark areas, as no basic light levels may be required to obtain reliable measurements within the area. Dark areas have an advantage that the potential intruder cannot study the area before potentially entering it. Furthermore, the intruder may need to carry his own light which decreases his flexibility.

The radar system may be any system which provides a radio waves based measurement signal on the basis of which the presence of a living body or moving object within the area can be determined.

The illumination device will only be activated when an intruder has been identified. Not for every object present in the area and detected by the radar system will it be desirable to activate the illumination device. It is, for instance, possible that an animal such as a dog, bird or cat may enter the area. It is also possible that there are permanent or semi-permanent objects in the area, such as flags or trees, which may be moved by the wind. To avoid illumination of such a moving object, the control device can be configured to determine, before the illumination device is activated, whether it is likely that the moving object is an intruder, for example on the basis of the intensity and/or shape of the detected signal or the location of the detected object. On the basis of the intensity and/or shape of the detected signal, distinction can, for instance, be made between moving objects of different sizes. On basis of the location, known permanently or semi-permanently present moving objects such as flags and trees can be recognized.

However, it is also possible that the control device is configured to activate the illumination device with every detected moving object, and to direct the light beam of the illumination device to the moving object. In that case the identification of an intruder in the area does not comprise anything more than the detection of a moving object in the area.

In an embodiment, the radar system is configured to determine the location of a moving object from a single position. By using such a radar system it is possible to arrange a single detection and illumination device, with which in an area to be secured, a moving object can be detected and, when desired, a light beam can be directed on the moving object.

In an embodiment, the radar system may comprise an emitter having an antenna to emit radio waves in the area, and one or more receivers, each comprising an antenna to receive reflections of the radio waves. The radar system may, for example, use a Doppler method or a frequency modulated continuous wave (FMCW) method to emit radio waves within the area, or a combination thereof. Any other suitable method to emit and receive radio waves may be applied. The antennas may be arranged in fixed positions or may be moved to scan the area.

The radar system may be used to measure reflections in the area which are compared to a reference reflection database of known reflections stored in a memory. The difference between measured reflections and reference reflections may be used to identify the presence of an intruder in the area.

The radar system may comprise one or more emitters to emit radio waves and one or more receivers to receive reflected radio waves. In an embodiment, the radar system is configured to scan the area in three dimensions. By means of a 3D radar system the coordinates of an object in the area can be determined more accurately. In an embodiment, the 3D radar system comprises multiple receivers and possibly multiple emitters. The 3D radar system may, for instance, comprise a steered beam radar or a stacked beam radar.

In an embodiment, the emitters and/or receivers are stationary mounted parts, and thus do not make any movement to scan a particular area. By using stationary mounted emitters and receivers less movable parts are required; this increases the reliability of the security system.

In an embodiment, the radar system comprises multiple radar modules, wherein each radar module comprises a measurement range. In an embodiment, each radar module comprises its own emitter and receiver. By using multiple radar modules the area can be subdivided in subareas, wherein each subarea is determined by the range of the associated radar module.

By arranging the radar modules next to each other, and arranging the measurement ranges of the radar modules at an angle with respect to each other, the detection or non detection of a moving object by a certain radar module can be used to determine in which subarea the moving object is present. By overlapping the subareas, namely by overlapping the measurements ranges of the radar modules, the resolution can be further increased. When a moving object is detected in the subareas of two adjacent radar modules, it can be determined that the moving object is located in the overlapping part of the two subareas.

In an embodiment, each radar module is configured to determine a distance to the moving object. The distance can for instance be determined by using a modulated radar signal, such as a saw tooth-signal, triangular-signal or a trapezium shaped-signal. By determining in which subarea a moving object is located and the distance to the object, the location of the moving object can relatively accurately be determined. Thereby, information on the terrain where the radar system is set up can increase the accuracy.

In an embodiment, the radar modules are set up as a matrix of rows and columns, whereby adjacent rows and/or columns are arranged at an angle with respect to each other. By using a radar system it is possible to determine the coordinates of a moving object within a secured area, which makes it relatively simple to direct the light beam of the illumination device at the location of the moving object.

Since the location of the moving object is determined in coordinates with respect to the location of the radar system, it is possible to calculate these coordinates to global coordinates and to send these. The coordinates can for instance be sent to a mobile navigation module configured for this, so that the navigation module directly after receipt of the coordinates can choose the quickest route to this location.

In an embodiment, the radar system, the control device, the illumination device and the actuator form an autonomous unit which can be arranged at a single location. An autonomous unit means that the detection and illumination device on its own is capable of detecting a location of a moving object in a certain area and to direct the illumination source at this location. By providing an autonomous unit, the location of a moving object can be determined from a single position. Triangulation from different points in the area may not be required to determine the location of the object.

The illumination device may comprise any light source, such as a xenon, LED, halogen, or laser radiation source. In an embodiment, the illumination device provides, when activated, a light beam with high power so that the living body illuminated by the illumination device experiences an uncomfortable feeling when being illuminated. In particular, when the intruder is illuminated in relatively dark surroundings, the intruder may feel disoriented. As a result, the intruder will feel encouraged to leave the secured area directly.

Since the high power illumination device will not be active most of the time, the power consumption of the illumination device is of less relevance when compared to illumination devices continuously illuminating the area as used in known systems.

In an embodiment, the area may be illuminated at a low level when no intruders are detected. As soon as an intruder is identified, he may be illuminated with a high power light beam and the further area may be darkened by shutting off the low level illumination of the area.

The actuator may comprise one or more servomotors capable of moving the illumination device to direct the light beam to a desired location. In an embodiment, the actuator comprise two servomotors, for example one for rotation about a vertical axis and one for rotation about a horizontal axis. Any other device capable of directing the light beam to a desired location may be applied.

In an embodiment, the control device comprises a memory in which one or more boundaries of said area is stored. It is desirable that a living body will only be illuminated when it actually has entered the area. However, a person passing by, but not entering the area, may also be detected by the radar system. To avoid that such a person is identified as an intruder, the boundary of the area may be stored in the control device, and the determined location of the intruder may be compared with the boundary. The illumination device may only then be activated when the person enters the area by passing the boundary of the area.

In an embodiment, the secured area may be subdivided in area zones, and an alarm level may be set for each of these zones. For instance, when the secured area surrounds an object, for instance a building, zones with different, in particular increasing, alarm levels may be defined around the object.

In such a security system, when an intruder is identified in the most external zone, only a relative soft alarm sound may be given, or a low power light beam may be directed to the intruder. When the intruder enters a next zone a next alarm level may be activated wherein the intruder for instance is illuminated by a high power light beam. When the intruder would further approach the building, he may enter a next zone wherein for instance a very loud alarm sound will be activated and an emergency center or the owner of the object or other person automatically will be called.

In an embodiment, the control device comprises a memory storing reference objects to identify objects of different types. It is possible that living bodies, such as animals, enter the secured area. Generally it is undesired that the presence of such animals in the area will lead to activation of the illumination device. Therefore, reference objects may be compared with the identified object to identify the type of object, human, animal or other, present in the area.

In an embodiment, the system comprises a monitoring device to be arranged at a location remote of said radar system, said control device and/or said illumination device, respectively, wherein said monitoring device is configured to control the functioning of the radar system, control device and/or illumination device. By providing a monitoring device which monitors the functioning of the radar system, control device and/or illumination device, any malfunctioning of the security system may be detected and reported.

In an embodiment, the monitoring device is stored at a remote location which cannot easily be reached by the intruder so that any sabotage of the radar system, control device and/or illumination device is detected and reported. For instance, the monitoring device may be arranged in an office building of which the surrounded area is secured by the security system. When any of the radar system, control device and/or illumination device, which are typically arranged outside is sabotaged, the monitoring device may report this by automatically calling an emergency center or the owner of the building, or another person. Since the monitoring device is placed inside the building, this monitoring device cannot easily be sabotaged.

In an embodiment, the monitoring device is connected to an existing security system or is an integral part thereof.

In an embodiment, the control device and the monitoring device are connected wirelessly. As an alternative the control device and the monitoring device are connected by wire.

In an embodiment, the control device and/or the monitoring device comprises a telephone unit. Such a telephone unit may be used to call in case reporting of any event detected by the security system is desired.

In an embodiment, the security system further comprises a vibration detection system, a video camera, a speaker and/or a microphone, in particular a directional microphone.

A vibration detection system may be provided to record unusual vibrations of the security system, and therewith determine attempts to sabotage the security system.

A video camera may be provided to capture video images of any person or other object detected within the area. The video images may be stored in a hard disk, another storage device or transferred to another location, for instance an emergency center and/or the owner of the building or another person. For instance, when an intruder is identified within the area the video camera may capture video images which images are sent to a mobile device, such as PDA or telephone.

In an embodiment the video images may be projected in or close by the area, for instance on the secured building so that the intruder can see himself. This makes the intruder aware that he is spotted in video images.

The video camera can be mounted on the illumination device such that the camera is directed to an intruder together with the illumination device.

In an embodiment the video camera is capable of zooming and being directed to certain locations. Since the radar system is capable of determining the location of the intruder within the area, the video camera may be directed to this location, and the images may be made in close up to increase the chance that the intruder is recognized.

A speaker may be provided to produce alarm sounds or to speak to the intruder. The text directed to the intruder may be played from a playing device, or directly be spoken, for instance from an emergency center, or via a mobile device. An advantage of directly spoken text is that the text may be adapted to the intruder. For instance the colors of his clothes may be mentioned. This makes the intruder aware that somebody actually sees him.

Further a microphone may be provided, with which it is possible to detect sounds in the secured area. The microphone may also be used to communicate with the intruder. For example use is made of a directional microphone which is directed to the intruder, such that his voice properly can be detected. The directional microphone can, possibly together with a video camera, be mounted on the illumination device, such that these together with the illumination device are directed to the intruder.

In an embodiment, at least the radar system, the illumination device, and the actuator are arranged in a detection and illumination unit. Providing a single unit in which these parts are arranged results in a compact system that easily can be mounted at a suitable location, for instance on existing objects such as lamp posts, masts and such. In an embodiment, at least an emitter and/or a receiver of the radar system are mounted at the underside or side of the unit to obtain a suitable measuring range with respect to the secured area.

Often, the radar system, the illumination device, and the actuator will be arranged outside, and thus will be subject to environmental circumstances such as rain and wind. A housing may be provided to protect the radar system, the illumination device, and the actuator against such external influences. The housing may be wind proof and watertight, and for instance be made from metal and/or plastic. Any transparent material in the housing may be provided with an anti-mask coating to avoid that the unit may be sabotaged by paint or such. Other parts of the security system may also be arranged in the same housing and/or unit.

The detection and illumination device may, for instance, be mounted on a mast or an outside wall. Further, it is possible to design the detection and illumination device as a common street lighting lamp, such that the detection and illumination device is less notable in the street scene.

In an embodiment, the detection and illumination unit can be easily mountable on a temporary location and/or be arranged on a mobile support. Such a detection and illumination unit can advantageously be used on location where temporarily securing an area is desired, for instance on construction areas, storage areas, festival areas and such. In an embodiment, the detection and illumination unit is arranged on a movable, desirably wheeled, carriage to form a mobile unit. Such a mobile unit can easily be placed on a suitable temporary location. It is also possible to provide a mobile unit only comprising a sensor system or only comprising a illumination device. Other parts of the security system may be arranged on another mobile unit or in another way be arranged in the area to be secured. It is however desirable that the radar system, the control device and the illumination device are provided as an autonomous unit. Placing such a unit is easier, and also may make a calibration of the parts with respect to each other during mounting unnecessary.

In an embodiment, the security system comprises a portable unit'which can be recognized by said control device or said monitoring device to deactivate the security system with respect to a person carrying the portable unit. When the owner or another authorized person enters the secured area, it is undesired that the security system is activated. Such a person may carry a portable unit with which the security system may be deactivated. Also, it may be possible to actively or passively switch the security system to another mode when the portable unit is detected. In this other mode, the security system may be configured, for instance, to guide the person over the area by illumination with a low power light beam, or by illuminating the whole area to a certain light level. Such a portable unit may comprise a RF module having an RFID which communicates with an RF module arranged in the area and for instance connected to the control device.

The deactivation or mode switch may be carried out actively by input of a code or such on the portable unit, or may be carried out passively by recognition of the portable unit within the area.

The portable unit may be carried out as software stored in a programmable mobile device, such as a mobile telephone or PDA. Additionally or alternatively, a key pad or other input device may be arranged at the edge of the area for deactivation of the security system.

In an embodiment, the security system comprises multiple radar systems and multiple illumination devices to cover an area to be secured.

In an embodiment, there is provided a method for securing an area, the method comprising:

monitoring the area by determining a location of a moving object within said area using a radar system, and

directing a light beam to an intruder in said area based on a signal of the radar system.

With the method, it is possible to detect a moving object in a secured area, and to determine the location thereof. This information can be used to determine with the help of a control device whether it is likely that the detected moving object is an intruder. In that case the control device can activate an illumination device providing the light beam and steer an actuator to direct the light beam to the location where the moving object, i.e. at the intruder who is detected.

In an embodiment the method comprises comparing a signal of said radar system to one or more boundaries of said area, reference objects and/or known reflections within the area to identify the living body as an intruder.

In an embodiment, the method comprises monitoring the functioning of the radar system, of a control device controlling the directing the light beam and/or of an illumination device providing the light beam, with a monitoring device arranged at a location remote of said radar system, said control device and/or said illumination device, respectively.

In an embodiment, the method further comprises projecting video images of said intruder and/or providing audible alarm signals and/or speaking to or communicating with said intruder.

### BRIEF DESCRIPTION OF THE DRAWINGS

Further features and advantages will now be described with respect to a security system according to an embodiment of the invention, while reference is made to the accompanying drawings in which:

FIG. 1 shows a schematic overview of an application of the security system according to an embodiment of the invention;

FIG. 2 shows schematically different parts of an embodiment of the invention;

FIG. 3 shows a schematic overview of an alternative embodiment of the security system;

FIGS. 4 and 5 show a detection- and illumination unit according to a further embodiment of the invention;

FIG. 6 shows a schematic top view of an arrangement of radar modules and the measurement ranges thereof;

FIG. 7 shows a schematic side view of an arrangement of radar modules and the measurement ranges thereof; and

FIG. 8 shows a schematic top view of an arrangement of a set of alternative radar modules and the measurement ranges thereof.

### DETAILED DESCRIPTION

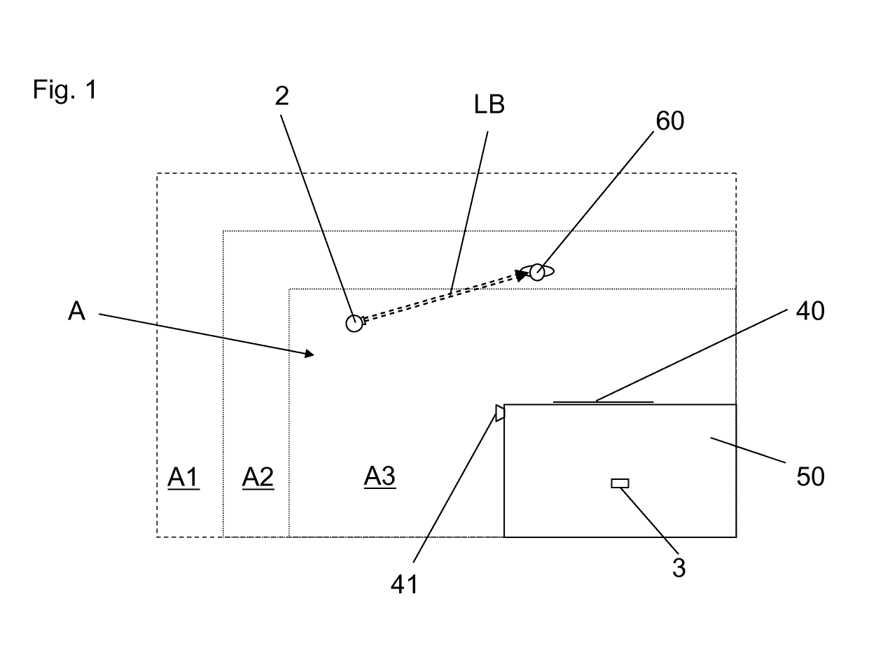

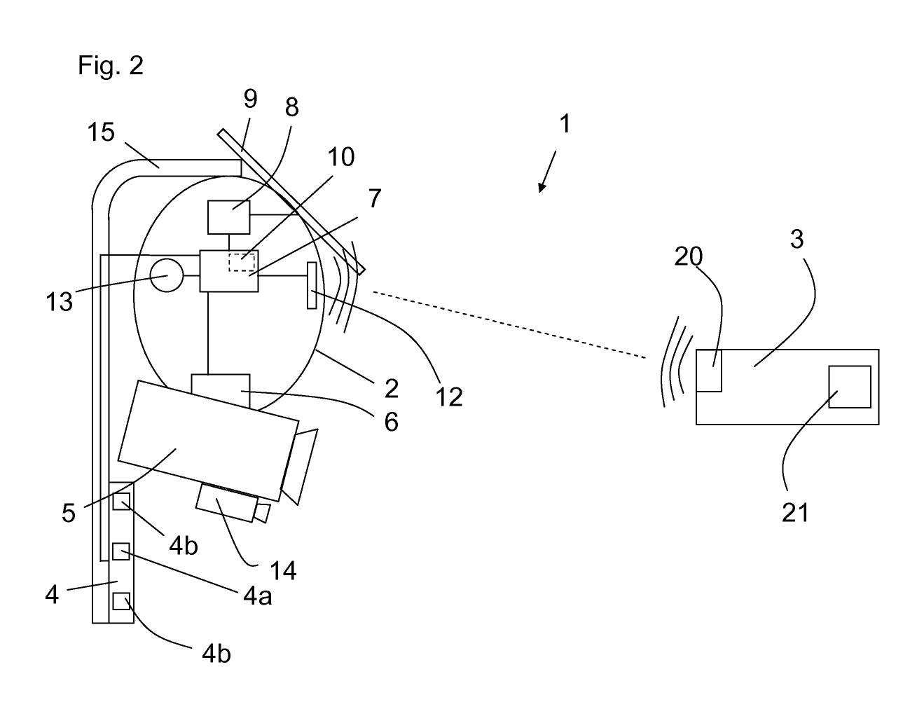

FIGS. 1 and 2 show a security system, according to an embodiment of the invention, to secure an area. The security system is generally indicated with the reference numeral 1. The security system comprises a detection and illumination unit 2 and a monitoring unit 3.

The security system 1 is configured to secure an area A surrounding a building 50. The secured area A is subdivided in three zones A1, A2, A3, each zone having its own alarm level. As an alternative, the secured area may comprise only one zone with a single alarm level.

When an intruder 60 is detected by the detection and illumination unit 2 in the most external zone A1, only a relative soft alarm sound is produced, to indicate to the intruder that he is detected. Also, the detector and illumination unit 2 may provide a low power light beam directed to the intruder 60 to make him aware that he has been detected.

When the intruder 60 enters the next zone A2, a next alarm level may be activated. IN this zone A2, the intruder is illuminated by a high power light beam LB of the detection and illumination unit 2, as shown in FIG. 1. Such high power light beam will give the intruder an uncomfortable feeling. The high power light beam may disorientate the intruder. He will feel encouraged to leave the secured area.

When the intruder would further approach the building, he may enter a next zone A3, wherein for instance a very loud alarm sound will be activated and an emergency center or the owner of the object or any other relevant person automatically will be called.

A monitoring unit 3 is provided within the building 50. The monitoring unit 3 continuously controls the functioning of the detection and illumination unit 2. Any malfunctioning of the detection and illumination unit 2, for instance caused by successful sabotage, will directly be detected and reported. Since the monitoring unit 3 is arranged inside the building it is very difficult to sabotage the monitoring unit 3.

The different parts of the security system will now be described in more detail.

FIG. 2 shows the detection and illumination unit 2 and the monitoring unit 3.

The detection and illumination unit 2 comprises a radar system 4 capable of detecting the location of an object in the area, an illumination device 5 to provide a light beam said light beam being directable to different locations in said area, an actuator 6 to direct said light beam to a desired location, and a control device 7 configured to activate the illumination device 5 and to control the actuator 6 to direct the light beam resulting from activation of the illumination device to the location where the intruder is located. The actuator 6 may, for example, comprise two servomotors capable of moving the illumination device or part thereof to direct the light beam emitted by the illumination device to a desired location within the secured area A. The first servomotor is, for example, rotatable about a horizontal axis, while the second servomotor is rotatable about a vertical axis.

The security system further comprises a power source 8, for instance a chargeable battery pack or accu, which is connected to a solar panel 9 to charge the power source 8.

For an optimal measuring range, the radar system is arranged at the underside of the detection and illumination unit 2. A brace 15 is provided on which at a bottom side the radar system 4 is mounted and at the opposite side a housing is arranged with the other parts of the detection and illumination unit 2. The radar system 4 is connected to the control device 7.

The radar system 4 comprises an emitter 4a having an antenna to emit radio waves in the area, and one or more receivers 4b, each comprising an antenna to receive reflections of said radio waves.

The emitter 4a and receiver 4b are stationary parts, i.e. are not mounted movably to make, for example, a scanning movement.

The radar system 4 uses a Doppler method to determine whether a moving object is present in the area. When a moving object has been detected in the area the radar system may switch to a frequency modulated continuous wave (FMCW) mode. In this mode, a signal with alternating increasing and decreasing frequency is emitted. The receiver 4b may detect a frequency difference between the emitted signal, which is used as a reference signal, and the reflected signal received by the receiver.

This change in frequency is dependent on the travel time of the radio waves from the emitter to the object and back to the receiver including the Doppler difference due to movement of the object. On the basis of the signals the distance and speed of any reflecting object may be determined.

Any other suitable method, for instance only a Doppler method, may be used for determining the presence of a moving object in the area.

In an embodiment, use is made of a 3D radar system with which the coordinates of an object in the area in three dimensions may be determined. Therewith, the accuracy can be increased.

By comparison of the determined moving objects and known reflections of the area, which is stored in a memory 10 in said control device 7, the location of a moving object within the area may be determined.

When a moving object is detected in the secured area, the reflections of the moving object may be compared with known reference reflections of different objects.

In this way, it may for instance be determined whether the detected object is a person or an animal. In this way, the security system 1 may only be activated when a person has been identified in the area A. This identification can, for instance, be based on the intensity with which the radar signal is reflected.

The memory 10 further comprises a map with the one or more boundaries of the area A and the zones A1, A2, and A3. When the presence of a person is identified by the radar system 4, the location of this person is compared with the map with the boundaries of the different zones. Dependent on the location of the person with respect to the map, the alarm level may be determined. For instance, when the person is located outside the area A when detected no alarm will be activated. When the person is detected in the second zone A2, the actuator moves the illumination device 5 to direct a high power light beam to the location of the person.

The boundary information may, for instance, be obtained after installation of the detection and illumination unit 2 by registration of the detected reflections of someone following the one or more boundaries of the area A.

The illumination device 5 comprises a xenon light source to produce a high power light beam so that the person illuminated by the illumination device 5 experiences an uncomfortable feeling when being illuminated. As a result, the intruder will feel encouraged to directly leave the secured area A. The illumination device 5 may comprise lenses and mirrors to focus the light emitted by the light source.

The security system 1 illuminates the location where an intruder is located by the radar system. When the intruder moves within the area, the light beam may follow the intruder until the intruder has left the area. As a result the intruder has the feeling of being surveyed in the area.

The detection and illumination unit 2 further comprises a wireless transmitter-receiver 12 to communicate with a wireless transmitter-receiver 20 of the monitoring unit 3. The monitoring unit 3 further comprises a telephone unit 21 which is capable of automatically calling one or more pre-programmed telephone numbers, for instance of an emergency center or the owner of the object or any other relevant person.

The detection and illumination unit 2 comprises a vibration detection system 13, which is capable of determination of unusual vibrations in the detection and illumination unit 2. The detection of such vibrations may be used to monitor possible attempts to sabotage the detection and illumination unit 2 by hefty movements caused by kicking against the detection and illumination unit 2 or its support.

Further, a video camera 14 may be provided to capture video images of any person or other object detected within the area. The video images may be stored in a hard disk or transferred to another location, for instance an emergency center and/or the owner of the building or another person. For instance, when an intruder is identified within the area the video camera may capture video images which images are sent to a mobile device, such as a PDA or telephone.

In an embodiment the video images may be projected on the secured building 50 (see screen 40 in FIG. 1) so that the intruder 60 can see himself projected on the screen 40. This makes the intruder aware that he is spotted in video images.

The security system 1 may comprise a speaker 41 (FIG. 1) provided to produce alarm sounds or to speak to the intruder. The text directed to the intruder may be played from a playing device, or directly be spoken, for instance from an emergency center, or via a mobile device. An advantage of directly spoken text is that the text may be adapted to the intruder. For instance the colors of his clothes may be mentioned. This makes the intruder aware that somebody actually is watching him.

Further a microphone, desirably a directional microphone, can be provided with which sounds in the secured area can be recorded. Herewith it is possible to communicate with an intruder using the speaker and microphone. The speaker and microphone can be mounted to a building, as shown in FIG. 1, or at any other suitable location, but are desirably mounted on the detection and illumination device 2.

The detection and illumination unit 2 and/or the monitoring unit 3 may further comprise a USB or network connector, a video out, an emergency power source, a sabotage alarm unit which reports sabotage or malfunctioning of the respective unit, and other detection, registration and/or communication systems.

In an embodiment, the security system 1 comprises a portable unit (not shown) which can be recognized by said control device or said monitoring device to deactivate the security system with respect to a person carrying the portable unit. When the owner or another authorized person enters the secured area, it is undesired that the security system is activated. Such person may carry a portable unit which with which the security system may be deactivated. Also, it may be possible to actively or passively switch the security system to another mode when the portable unit is detected. In this other mode, the security system may, for instance, be configured to guide the person over the area by illumination with a low power light beam, or by illuminating the whole area to a certain light level.

The mode switch may be carried out actively by the user by input of a code or such on the portable unit, or may be, as an alternative, carried out automatically by recognition of the portable unit within the area. Such portable unit may comprise a RF module having an RFID which communicates with an RF module arranged in the detection and illumination unit 2 or at any other suitable location.

The portable unit may be carried out as software stored in a programmable mobile device, such as a mobile telephone or PDA. Additionally or alternatively, a key pad or other input device may be arranged at the edge of the area for deactivation of the security system.

In an embodiment, the security system comprises multiple radar systems and multiple illumination devices to cover an area to be secured.

In the embodiment of FIGS. 1 and 2, the detection and illumination unit 2 comprises a radar system 4 and an illumination device 5. Such detection and illumination device can function as an autonomous unit which in itself is capable of detecting the location of a moving object and directing a light beam on the moving object. In other embodiments, the radar system 4 and the illumination device 5 may be provided as separate units. Also, multiple radar systems 4 and multiple illumination devices 5 may be provided to cover an area to be secured.

The detection and illumination unit 2 may be arranged on a fixed post at a suitable height. The detection and illumination unit 2 may be arranged at the roof of a building or any other suitable location. In an embodiment, the detection and illumination unit is arranged on an existing object, such as a lamp post, advertising column, building or such, such that no separate object has to be provided to mount the detection and illumination unit 2 at a suitable height.

In an embodiment the detection and illumination unit 2 may be arranged on a movable unit. Such an embodiment may be used in a security system which can easily be set up and removed when a certain area, such as a construction area, storage area, festival area or such, only temporarily has to be secured.

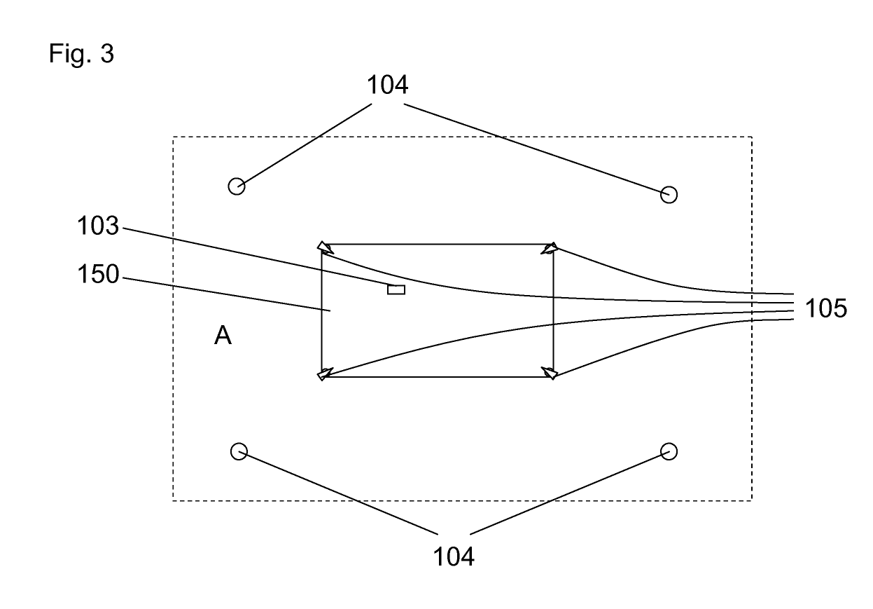

FIG. 3 shows an alternative setup of a security system, according to an embodiment of the invention, which is configured to secure an area A surrounding a building 150. The security system comprises four radar systems 104 configured to detect a moving object, in particular an intruder in the area A. When an intruder is detected one or more of the illumination devices 105 may be used to illuminate the intruder at the location where he is detected.

Each illumination device 105 comprises an actuator configured to move the illumination device, or at least a part thereof, to direct the light beam of said illumination device 105 to the intruder. In this way the intruder will be followed by at least one light beam as long as the intruder is present in the area A. The radar systems 104, the illumination devices 105 and the monitoring unit 103, which is arranged in the building 150, communicate with each other, desirably by means of wireless communication.

Other parts of the security system as described and shown in FIG. 2 may be arranged in one or more of the radar systems 104, the illumination devices 105 and/or the monitoring unit 103, or may be arranged at any other suitable location.

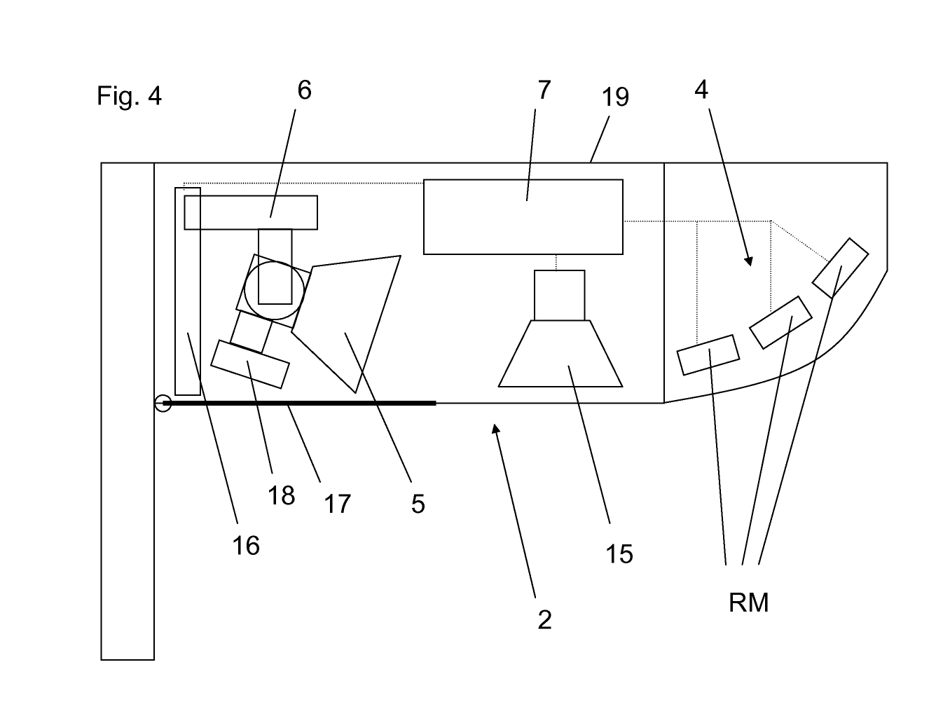

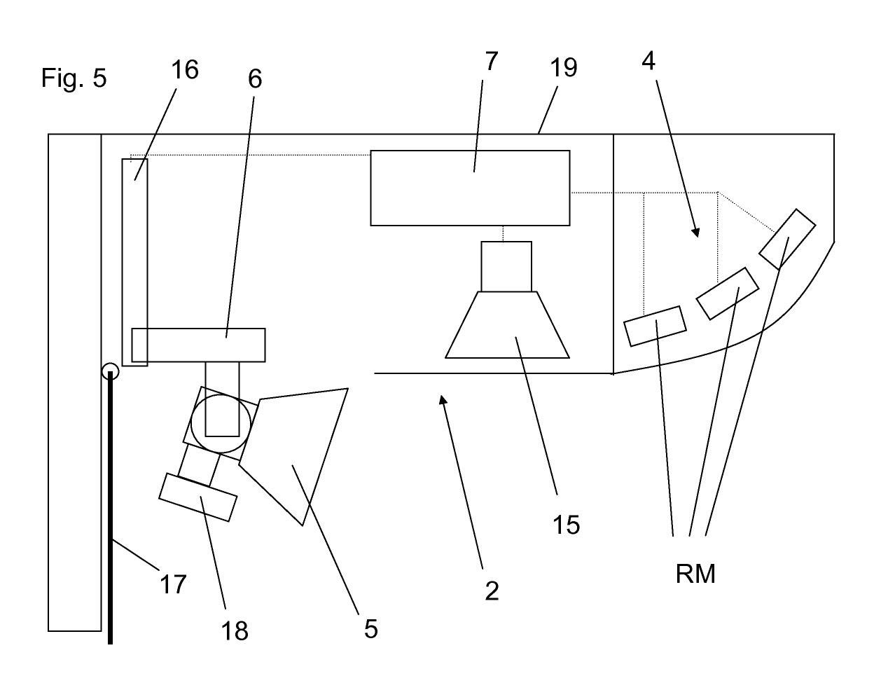

FIGS. 4 and 5 show a further embodiment of a detection and illumination device 2. Same parts or parts with a same function are indicated by the same reference numeral.

The detection and illumination device 2 comprises a radar system 4, an illumination device 5 to provide a directable light beam, an actuator 6 to direct the light beam to a desired location, and a control device 7 to activate the illumination device 5 and control the actuator to direct the light beam.

The detection- and illumination unit 2 can further be provided with an energy source, a memory, a wireless transmitter-receiver, a vibration detection system, a speaker, a (directional) microphone and/or a camera, as described with respect to the embodiment of FIG. 2. These parts can for instance be arranged in a housing 18 on illumination device 5, in particular the (directional) microphone and the camera, so that these can be directed to the moving object together with the illumination device. Other parts can be arranged at a suitable location in the housing 19.

The detection and illumination device 2 is designed in such a way that it has the appearance of a normal street lighting lamp. For this reason, the housing 19 of the detection and illumination device 2 has the shape of such normal street lighting lamp, and the illumination device 5 together with the actuator 6 are movably arranged on a rail 16 in the detection and illumination device 2. Further, a stationary lamp 15 is provided which functions as a common street light. In an alternative embodiment such stationary lamp 15 can be absent, or the illumination device 5 can also be used as a stationary lamp by using it below full power.

FIG. 4 shows the detection and illumination device 2 in normal condition, i.e. no intruder has been detected. The illumination device 5 is located in an upper position with respect to the rail 16 and falls within the housing 19 of the detection and illumination device 2. A lid 17 is provided to keep the housing in this condition closed.

FIG. 5 shows the same detection and illumination device 2 in alarm condition, i.e. when there is detected an intruder. In this condition the lid 17 is opened and the illumination device 5 with the actuator 6 is moved downwards to a lower position, for instance by means of a linear actuator. In this condition the light beam can be directed by means of the actuator 6 to the location where an intruder is detected. For movement of the lid 17 a separate actuator can be provided, but it can also be coupled with the vertical displacement of the illumination device 5 and the actuator 6.

An advantage of this design of the detection and illumination device 2 is that when it is arranged in the normal condition it does not directly show that a special security system is provided. Furthermore, for placing the detection and illumination device 2, the optical (street) scene does not have to be disturbed since an existing street light can be replaced by the detection and illumination device 2.

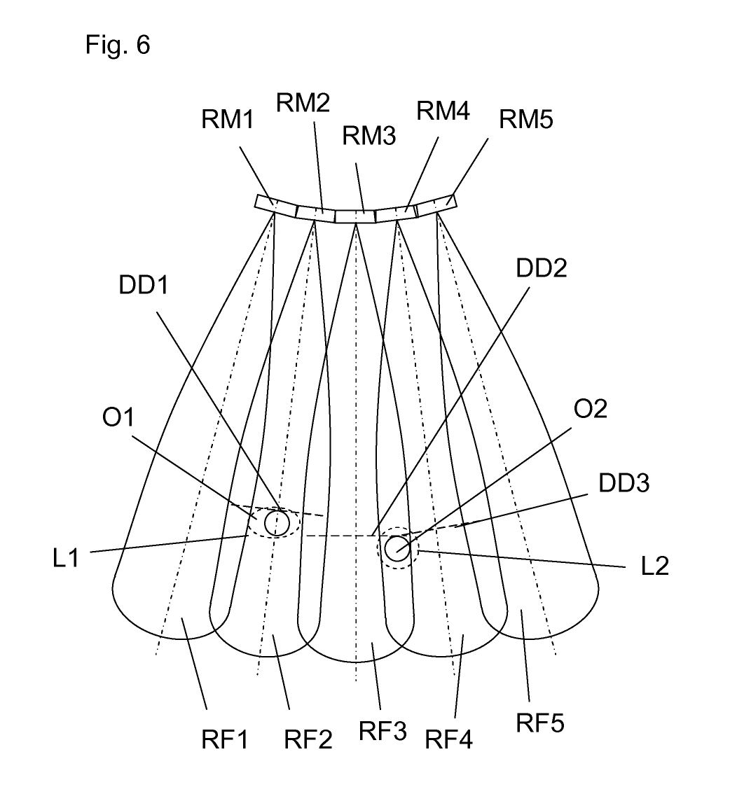

The radar system 4 comprises three rows of radar modules RM. The, in this case, five radar modules RM within a row are arranged at an angle with respect to each other (see FIG. 6), and each of the rows are also arranged at an angle with respect to each other. Each of the radar modules comprises at least an emitter and at least a receiver, with which the distance to a moving object can be determined when the object is located within the measurement range of the respective radar module.

By subdivision of the area to be secured in a number of overlapping or non-overlapping subareas, whereby each of the subareas is determined by the measurement range of a radar module, it can be determined in which subarea the moving object is located. Since the radar modules also are capable of determining the distance to the moving object, a location of a moving object can be determined on the basis of measured distance and the one or more subareas in which the moving object is present.

In an embodiment, the location of the moving object can be determined in a coordinate system associated with the respective radar module(s). Thereafter these coordinates may possibly be calculated to coordinates with respect to the illumination device. In this way, the illumination device can easily be actuated to shine the light beam to the correct location in the area to be secured.

As an alternative for this radar system it is also possible to provide a radar system with one or more radar modules, wherein each radar module is capable to detect from a single location the location of the moving object within the measurement range of the radar module. These radar modules do not only measure the distance to the moving object, but also the angle with respect to the radar module. Then no or less overlap between the measurement ranges of the radar modules is required even when the measurement ranges are relatively broad. This may have an advantage that less radar modules may be required to cover a certain area.

With the radar system 4 or the just described alternative radar system it is possible to provide the detection and illumination unit 2 as an autonomous device; i.e. the detection and illumination device is in itself capable to detect a location of a moving object in a certain area and to direct the light beam of the illumination device 5 to this location.

An advantage of such autonomous detection and illumination device 2 is that it does not have to be calibrated after mounting. This calibration can already be carried out before placing the detection and illumination device, for instance during or directly after fabrication.

FIG. 6 shows how the radar modules RM are used to detect the location of a moving object in a secured area. In FIG. 6 a row of 5 radar modules RM1-RM5 is provided. For each of the radar modules RM1-RM5 a measurement range RF1-RF5 is shown. The radar modules RM1-RM5 are arranged at an angle with respect to each other such that the measurement ranges of the radar modules RM1-RM5 are adjacent with an overlap. FIG. 6 shows an example of the measurement ranges. In practice, it will be desired that the total angle of the measurement ranges of the radar modules RM1-RM5 together is for instance 180 degrees.

Each radar module is a stationary unit and comprises at least an emitter and receiver. The radar modules are of the continuous wave type, and to make it possible to determine a distance to the detected object with the radar module, the radar signal is modulated, for instance by using a saw tooth, a triangle or a trapezium shape signal. In practice, the radar module can comprise a radar emitter which generates a modulated signal in itself, or as an alternative, the radar emitter can be fed with a modulated input signal.

The measurement range of a radar module RM1-RM5 has for instance in the measurement direction a length of for instance 10 to 50 meters, desirably 20 to 35 meters. The width of the measurements range is for instance 1 to 6 meters, desirably 2 to 4 meters at 25 meters distance from the radar module.

With a radar module RM1-RM5, it is possible to determine whether a moving object is present in the measurement range of the respective radar module and, when this is the case, what the distance to the moving object is with respect to the radar module. On the basis of these data, a location of the moving object can be determined. It may be possible to determine on the basis of the intensity of the reflected signal the size of the moving object. With this information it can for instance be determined whether the object has the dimensions of a human being or of a cat or a dog or such. In this way an intruder can be identified.

As an alternative or in addition thereto use can be made of a camera to determine whether there is a human intruder.

In FIG. 6 an object O1 is drawn. The object O1 is present in the measurement range RF2 of the radar module RM2. The object O1 is thus only detected by the radar module RM2 at a detection distance DD1. The object O1 is however not detected by the adjacent radar modules RM1 and RM3. With this information it can be determined that within the area indicated by L1 a moving object is present. Therewith the location L1 of the object O1 is determined.

A second object 02 is present in the overlapping area of the measurement ranges RF3 and RF4 of the radar modules RM3 and RM4. Since the object 02 is detected by both radar modules RM3 and RM4, it can be determined that the object is located in the overlapping area of the measurement ranges RF3 and RF4. Since by the radar modules RM3 and RM4 it is determined that the object 02 is located at the distances DD2 and DD3 respectively, it can be determined that the second object 02 is located at the location L2.

It is remarked that the radar system 4 cannot determine within an overlapping or non-overlapping part where the object is exactly located. Only presence and distance are determined within the measurement range of a radar module. The resolution is in particular determined by the width of the measurement range and the overlap of the measurement areas of adjacent radar modules. Increasing the overlap of the measurement ranges will also increase the resolution of the radar system, but this has the result that more radar modules per row are required to cover the same area.

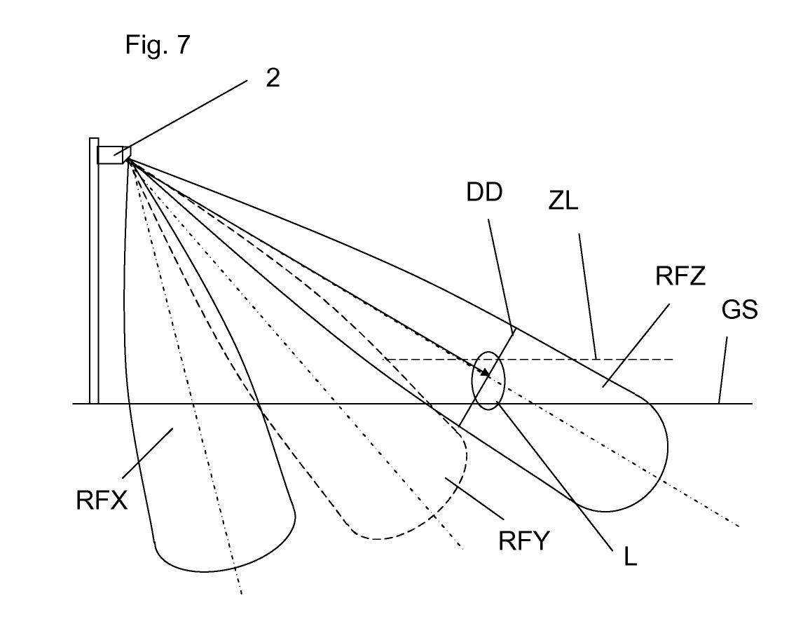

FIG. 7 shows a detection and illumination device 2 mounted on a post. In FIG. 6 a secured area is shown which is covered by one of the rows of radar modules RM of the detection and illumination device 2. As shown in FIGS. 4 and 5 the detection and illumination device 2 comprises multiple rows of radar modules which are each arranged at an angle with respect to each other. In this way a matrix of radar modules is provided which cover together a secured area. In FIG. 7 is shown how the respective rows of radar modules with measurement ranges RFX, RFY and RFZ can be arranged. In the direction perpendicular to the drawing the radar modules of the separate rows are arranged as a top view thereof is shown in FIG. 6. In this way a ground surface area GS can be secured with this matrix of radar modules.

To increase the accuracy of the radar system 4 further use can be made of the information of the surroundings in which the detection and illumination device 2 is arranged. For instance it can be expected that a moving object is present in a zone between the ground surface area GS and a height of, for instance, 2 meters. By using this information and the measured distance to the object it can, for instance, be determined whether a moving object is present at the front or at the back within a certain area.

For instance in FIG. 7, the height of the zone is indicated by ZL and the measured distance is indicated by DD. Since the moving object cannot be located above the line ZL or below the ground surface area GS, it is possible to determine the location L with more accuracy.

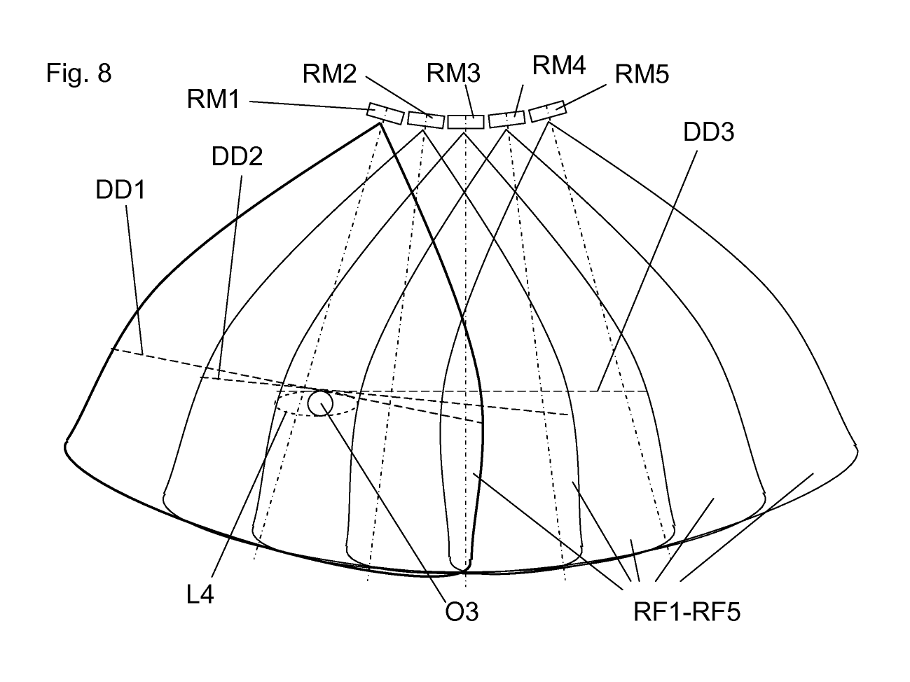

FIG. 8 shows an arrangement of five alternative radar modules RM1-RM5 which are arranged at different angles with respect to each other within a row. Each radar module RM1-RM5 has a more wide measurement range RF1-RF5. The measurement ranges RF1-RF5 have a relatively large overlap. In the middle of the common measurement range there is even an area which is covered by all five radar modules RM1-RM5.

Due to the wide measurement ranges RF1-RF5 each radar module RM1-RM5 is capable to determine over a larger width whether a moving object is present, but at the same time the location where the detected moving object is determined is less accurate per radar module. However, due to the different overlaps of a number of radar modules it is equally well possible to determine the location of a moving object with sufficient accuracy. The determined location can be used to illuminate the moving object with the directable light source of the detection and illumination device.

For instance in FIG. 8 an object 03 is detected by three of the five radar modules RM1-RM5 at a respective detection distance DD1, DD2, DD3. The object 03 is not detected by the other two radar modules RM4 and RM5. As a result, it can be determined that the object is located at the location L4, and the light beam of the illumination device 5 can be directed to this location.

1. A security system to secure an area, the security system comprising:
a sensor system to determine a location of a moving object within said area, the sensor system comprising a radar system;
an illumination device to provide a light beam said light beam being directable to different locations in said area;-,
an actuator to direct said light beam to a desired location; and
a control device configured to, in dependence of a signal of the sensor system, activate the illumination device and to control the actuator.

2. The security system according to claim 1, wherein the radar system is configured to determine the location of the moving object from a single position.

3. The security system according to claim 1, wherein the radar system is a 3D radar system.

4. The security system according to claim 1, wherein the location of the moving object is determined in a coordinates system.

5. The security system according to claim 1, wherein the radar system comprises multiple radar modules, wherein each radar module has a measurement range.

6. The security system according to claim 5, wherein the radar modules are arranged next to each other, wherein the measurement ranges of the radar modules are arranged at an angle with respect to each other.

7. The security system according to claim 5, wherein at least one of the radar modules is a continuous wave type radar module.

8. The security system according to claim 5, wherein each radar module comprises at least an emitter and at least a receiver.

9. The security system according to claim 5, wherein each radar module is configured to determine a distance to the moving object.

10. The security system according to claim 5, wherein each radar module uses a modulated radar-signal.

11. The security system according to claim 5, wherein the radar modules are arranged as a matrix of rows and columns, wherein adjacent rows and/or columns are arranged at an angle with respect to each other.

12. The security system according to claim 5, wherein the control device is configured to use information of the surroundings to determine the location of the moving object.

13. The security system according to claim 1, wherein the radar system, the control device, the illumination device and the actuator form an autonomous unit.

14. The security system according to claim 1, wherein the control device comprises a memory in which boundaries of said area are stored.

15. The security system according to claim 1, wherein the control device comprises a memory storing to store reference objects to identify objects of different types.

16. The security system according to claim 1, wherein the control device comprises a memory in which a database with known reflections of said area are stored.

17. The security system according to claim 1, further comprising a monitoring device to be arranged at a location remote of said control device, said radar system and/or said illumination device, respectively, and wherein said monitoring device is configured to control the functioning of the radar system, control device and/or illumination device.

18. The security system according to claim 17, wherein the control device and the monitoring device are wirelessly connected.

19. The security system according to claim 17, wherein the control device and/or the monitoring device comprises a telephone unit.

20. The security system according to claim 1, further comprising a vibration detection system, a video camera, a microphone and/or a speaker.

21. The security system according to claim 1, wherein at least the sensor system, the illumination device, and the actuator are arranged in a detection and illumination device.

22. The security system according to claim 1, wherein the detection and illumination device is mounted on a movable, preferably wheeled carriage to form a mobile unit.

23. The security system according to claim 1, further comprising a portable unit which can be recognized by said control device or said monitoring device to deactivate the security system with respect to a person carrying the portable unit.

24. The security system according to claim 1, comprising multiple radar systems and multiple illumination devices to cover an area to be secured.

25. A method for securing an area, the method comprising:
monitoring the area by determining a location of a moving object within said area using a radar system, and
directing a light beam to an intruder in said area based on a signal of the radar system.

26. The method according to claim 25, further comprising comparing a signal of said radar system to boundaries of said area, reference objects and/or known reflections within the area to identify the intruder.

27. The method according to claim 25, further comprising monitoring the functioning of the radar system, of a control device controlling the directing the light beam and/or of an illumination device providing the light beam, with a monitoring device arranged at a location remote of said control device, said radar system and/or said illumination device, respectively.

28. The method according to claim 25, further comprising projecting video images of said intruder and/or providing audible alarm signals and/or speaking to said intruder and/or communicating with the intruder.

29. The method according to claim 25, further comprising identifying a moving object as an intruder.

30. The method according to claim 25, further comprising storing an area to be secured in a control device controlling the directing the light beam.
